(19) United States
(12) Patent Application Publication
(10) Pub. No.: US 2019/0322246 A1
(43) Pub. Date: Oct. 24, 2019

(54) PORTABLE TRAILER WHEEL RINSING SYSTEMS AND METHODS OF USE THEREOF

(71) Applicant: Daniel Sarne, Englewood, FL (US)

(72) Inventor: Daniel Sarne, Englewood, FL (US)

(21) Appl. No.: 16/389,032

(22) Filed: Apr. 19, 2019

Related U.S. Application Data
(60) Provisional application No. 62/660,723, filed on Apr. 20, 2018.

(51) Int. Cl. B60S 1/66; B08B 3/02; B60P 3/10

(52) U.S. Cl. CPC B60S 1/66; B08B 2203/027; B60P 3/1033; B08B 3/02

(57) ABSTRACT

A portable trailer wheel rinsing system comprises at least one liquid storage tank configured to be attached to a trailer, a plurality of spray nozzles configured to be attached to the trailer and direct a liquid spray onto a wheel assembly of the trailer. The plurality of spray nozzles are in fluid communication with the at least one liquid storage tank and a pump is in fluid communication with the at least one liquid storage tank and the plurality of spray nozzles. A timer may be included and be in electrical communication with the pump. The timer is configured to activate the pump for a predetermined amount of time and the pump is configured to pump a liquid from the at least one liquid storage tank through the plurality of spray nozzles such that a liquid spray is applied to the wheel assembly for the predetermined amount of time.

### CROSS-REFERENCE TO RELATED APPLICATIONS

This application claims priority to U.S. provisional patent application No. 62/660,723 filed Apr. 20, 2018, the entire contents of which are herein incorporated by reference.

### TECHNICAL FIELD

The present specification generally relates to apparatuses and methods for rinsing wheels on a trailer and, more specifically, to portable apparatuses and methods for rinsing wheels of a boat trailer.

### BACKGROUND

The unloading and loading of a boat from a boat trailer (trailer) into and out of a body of salt water typically requires backing the trailer into the salt water such that the wheels, axle(s), etc., (wheel components) are submersed within and then removed from the salt water. After unloading the boat, the trailer is pulled out of the salt water and typically parked in a designated parking lot while the owner or user of the boat goes fishing, skiing, sightseeing, etc. After loading the boat, the trailer is pulled out of the salt water and used to transport the boat to a desired location such as the owner or user's home. In both instances, salt water remains on the wheel components of the trailer and may dry to form salt deposits. It is known that both salt water and salt deposits are corrosive to the wheel components of the trailer and may cause premature failure thereof. Accordingly, owners and users of such boat trailers may take the trailer to a car wash or other facility (e.g., home) to rinse the wheel components with fresh water. However, taking the trailer to a car wash or a home and manually rinsing the wheel components may be inconvenient. Also, salt deposits formed on the wheel components may be difficult to rinse off and require additional effort to ensure the wheel components are “salt free.”

Accordingly, a need exists for alternative systems and methods for rinsing salt water from the wheels, axle(s), etc., of a boat trailer.

### SUMMARY

In one embodiment, a portable trailer wheel rinsing system comprises at least one liquid storage tank, a plurality of spray nozzles, a pump, and a timer. The at least one liquid storage and the plurality of spray nozzles are configured to be attached to the trailer such that the plurality of spray nozzles direct a liquid spray onto a wheel assembly of the trailer. The plurality of spray nozzles are in fluid communication with the at least one liquid storage tank and the pump is in fluid communication with the at least one liquid storage tank and the plurality of spray nozzles. The timer is in electrical communication with the pump and is configured to activate the pump for a predetermined amount of time. The pump provides liquid from the at least one liquid storage tank to the plurality of spray nozzles such that a liquid spray is applied to the wheel assembly for the predetermined amount of time.

In another embodiment, a trailer with a trailer wheel rinsing system comprises a trailer with at least two wheel assemblies with brake and suspension components. At least one liquid storage tank containing a rinse liquid and at least two spray nozzles are attached to the trailer such that the spray nozzles spray the rinse liquid onto the brake and suspension components. A pump is in fluid communication with the at least one liquid storage tank and the plurality of spray nozzles, and a timer is in electrical communication with the pump. The timer activates the pump for a predetermined amount of time and the pump delivers pressurized rinse liquid from the at least one liquid storage tank to the at least two spray nozzles. The rinse liquid is sprayed onto and rinses the brake and the suspension component of each wheel assembly for the predetermined amount of time.

In still yet another embodiment, a method for rinsing salt water off of a wheel assembly of a trailer comprises activating a timer electrically connected to an electric pump attached to the trailer. The timer activates the electric pump for a predetermined amount of time and the electric pump provides fresh water contained in at least one liquid storage tank to a plurality of spray nozzles attached to the trailer. The plurality of spray nozzles are positioned proximal to and facing a plurality of wheel assemblies of the boat trailer, and the plurality of wheel assemblies are sprayed with the fresh water for the predetermined amount of time using the plurality of spray nozzles.

These and additional features provided by the embodiments described herein will be more fully understood in view of the following detailed description in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a top view of a boat trailer with a portable trailer wheel rinsing system according to one or more embodiments disclosed and described herein;

FIG. 2 schematically depicts a top view of the boat trailer of FIG. 1 with the portable trailer wheel rinsing system according to one or more embodiments disclosed and described herein;

FIG. 3 schematically depicts a partial cross-sectional view taken along the lines 3-3 of FIG. 1, according to one or more embodiments disclosed and described herein; and

FIG. 4 schematically depicts an electronic control unit having a timer for a portable trailer wheel rinsing system according to one or more embodiments disclosed and described herein

### DETAILED DESCRIPTION

According to one or more embodiments described herein, a portable trailer wheel rinsing system may generally comprise at least one liquid storage tank (referred to herein as a “saddle tank”), a pump, and a plurality of spray nozzles. The at least saddle tank, pump and spray nozzles are configured to be attached to the trailer and direct a liquid spray onto a wheel assembly of the trailer. As used herein, the phrase “wheel assembly” refers to a wheel and suspension components including but not limited to a rim, a tire, brake components, (including brake pads, brake discs), suspension components, and a spindle. The plurality of spray nozzles are in fluid communication with the at least one saddle tank and a pump is in fluid communication with the at least one saddle tank and the plurality of spray nozzles. A timer may be included and be in electrical communication with the pump. The timer is configured to activate the pump for a predetermined amount of time and the pump is configured to pump a liquid (e.g., fresh water) from the at least one saddle tank through the plurality of spray nozzles such that a liquid spray is applied to the wheel assembly for the predetermined amount of time. The portable trailer wheel rinsing system can be attached to a trailer and utilized to rinse wheel assemblies of the trailer with fresh water after a boat has been unloaded into a body of salt water and the trailer has been parked. In the alternative or in addition to, portable trailer wheel rinsing system may rinse the wheel assemblies of the trailer with fresh water after the boat has been loaded back onto the trailer and the individual is preparing the boat for travel and/or the individual is driving and pulling the trailer (with the boat loaded thereon) to a destination such as a home, boat storage facility, etc.

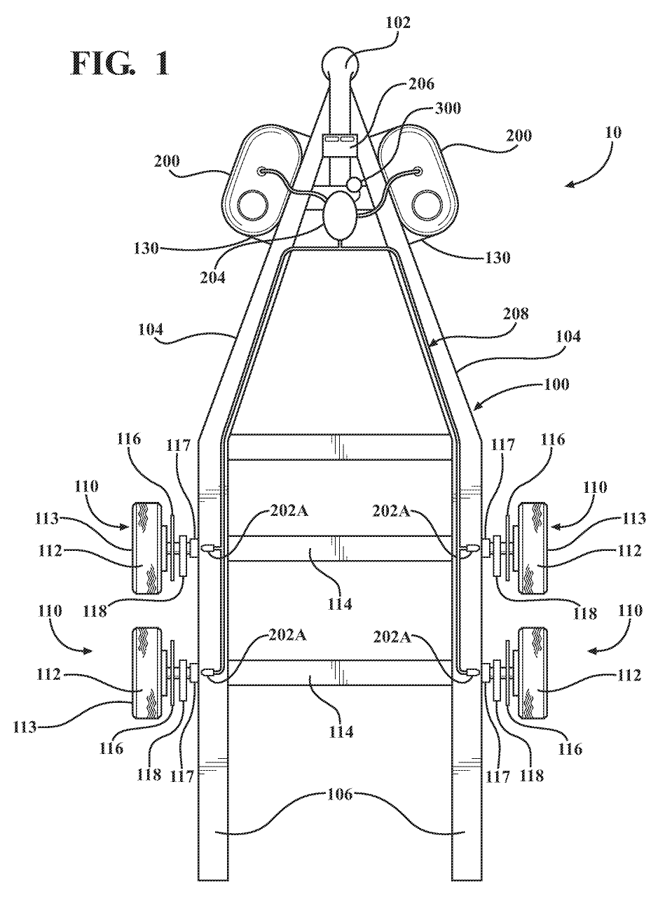

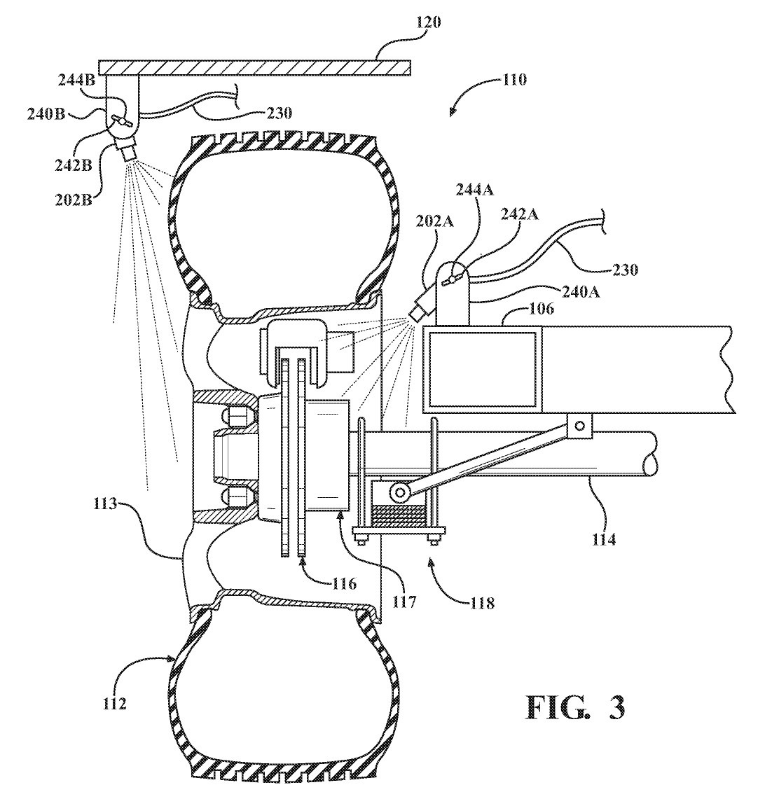

Referring now to FIG. 1 a top view of a portable trailer wheel rinsing system 10 is schematically depicted. The portable trailer wheel rinsing system 10 may be attached to a trailer 100 comprising a trailer hitch 102, a pair of front trailer frame members 104, and a pair of rear trailer frame members 106. At least one pair of wheel assemblies 110 is attached to the trailer 100, e.g., attached or mounted to the pair of rear trailer frame members 106, and each of the wheel assemblies 110 may include a tire 112, a wheel rim 113, a brake 116 (e.g., disk brake comprising a brake disc, calipers, disc brake pads), spindle 117, and a suspension component 118 (e.g., leaf springs, torsion springs, etc.). The at least one pair of wheel assemblies 110 may be mounted or attached to an axle 114 by the spindle 117, the axle 114 extends between the pair of wheel assemblies 110. As shown in FIG. 3, the trailer 100 may include a pair fenders 120 that are provided above each of the wheel assemblies 110, respectively. Each of the fenders 120 is connected to the rear trailer frame members 106.

The portable trailer wheel rinsing system 10 comprises at least one liquid storage (saddle tank) 200, a plurality of inner spray nozzles 202A, a plurality of outer spray nozzles 202B (shown in FIG. 3), a pump 204, and a battery 206. The at least one saddle tank 200 is configured to store a fluid for discharge through the plurality of inner spray nozzles 202A and the plurality of outer spray nozzles 202B. The pump 204 may be an electric pump 204. The battery 206 provides electrical energy to the electric pump 204. In some embodiments, the battery 206 may be provided in a vehicle, such as a pick-up truck, (not shown) used to pull the trailer 100. In some embodiments, the battery 206 is a 12V rechargeable battery.

The pump 204 is in fluid communication with the plurality of inner spray nozzles 202A, the plurality of outer spray nozzles 202B, and the at least one saddle tank 200 through one or more fluid lines 208. In embodiments, the fluid lines 208 may be formed from polymer hoses. In other embodiments, the fluid lines 208 may be formed from metal tubing, e.g., steel tubing, stainless steel tubing, copper tubing, or the like. In some embodiments, the pump 204 is a 12 volt (V) electric and weatherproof pump.

The portable trailer wheel rinsing system 10 may also include a timer electronic control unit (timer ECU) 300. The timer ECU 300 configured to control operation of the portable trailer wheel rinsing system 10 for a predetermined period of time. Specifically, the timer ECU 300 is configured to activate the pump 204 from an off state to an on state for the predetermined period of time. Upon elapse of the predetermined period of time, the timer ECU 300 is configured to deactivate the pump 204 from the on state to the off state. In the off state, the pump 204 does not receive electric power from the battery 206 and does not operated to pump the fluid stored in the at least one saddle tank 200 to the plurality of inner spray nozzles 202A and the plurality of outer spray nozzles 202B through the fluid lines 208. In the on state, the pump 204 receives electric power from the battery 206 and operates to pump the fluid from the at least one saddle tank 200 to the plurality of inner spray nozzles 202A and the plurality of outer spray nozzles 202B through the plurality of fluid lines 208.

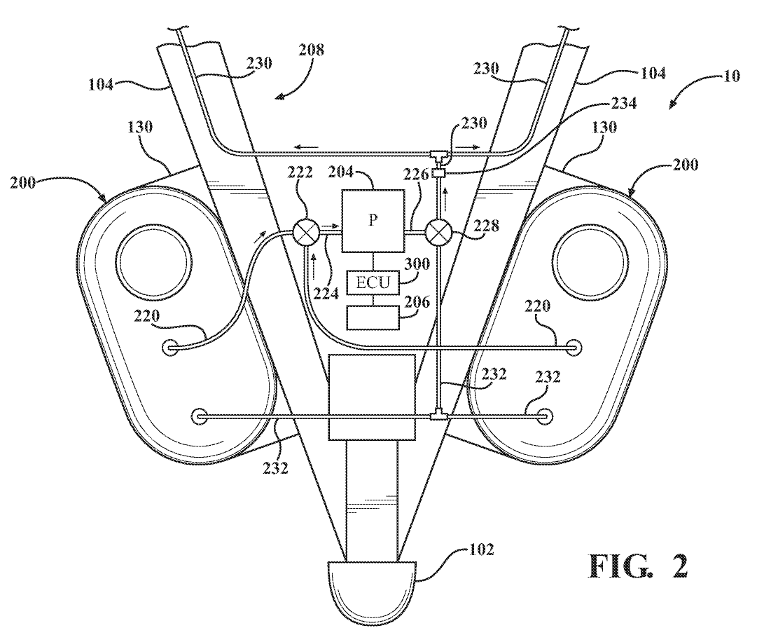

Referring now to FIGS. 1 and 2, the at least one saddle tank 200, e.g., two saddle tanks 200, may be mounted or attached to the pair of front trailer frame members 104. Particularly, one of the saddle tanks 200 may be mounted to one of the front trailer frame members 104 and another of the saddle tanks 200 may be mounted to another of the front trailer frame members 104. In some embodiments, a pair of saddle tank supports 130 may be rigidly attached to the pair of front trailer frame members 104 such that the pair of saddle tanks 200 are supported, held and attached to the pair of front trailer frame members 104. In other embodiments, the at least one saddle tank 200 may not be mounted or attached to the trailer 100. For example, the at least one saddle tank 200 may be positioned in a bed of the pick-up truck used to pull the trailer 100 (not shown).

Still referring to FIGS. 1 and 2, the pump 204 may be mounted to the trailer 100 and be in fluid communication with the pair of saddle tanks 200 via the fluid lines 208. Referring to FIG. 2, in some embodiments, the fluid lines 208 includes a pair of pump supply lines 220 that connect the pair of saddle tanks 200 to a first valve 222. In some embodiments, the first valve 222 is a three way valve having two inlets for the pair of pump supply lines 220 and an outlet that connects the first valve 222 to an inlet of the pump 204 by a pump inlet line 224. In some embodiments, the fluid lines 208 may also include a pump outlet line 226, a second valve 228, and nozzle supply lines 230. The pump outlet line 226 connects an outlet of the pump 204 to the second valve 228. The nozzle supply lines 230 are connected to the second valve 228 to supply the fluid to the plurality of inner spray nozzles 202A and the plurality of outer spray nozzles 202B.

In some embodiments, the second valve 228 is a three way valve having one inlet connected to the pump outlet line 226, and two outlets. One of the two outlets of the second valve 228 is connected to the nozzle supply lines 230 and the other of the two outlets is connected to a saddle tank return lines 232 that connects the second valve 228 to the pair of saddle tanks 200.

In some embodiments, the first valve 222 and the second valve 228 each include a handle to manual open or close the first valve 222 and the second valve 228. In some other embodiments, a pressure gauge 234 provided on the fluid lines 208. In some embodiments, the pressure gauge 234 is provided on the nozzle supply lines 230 adjacent the second valve 228. The pressure gauge 234 may be in electronic communication (i.e. either wired or wireless) to the timer ECU 300 to provide a detected pressure of the pump outlet line 226 or the nozzle supply lines 230. In some other embodiments, the pressure gauge 234 may have a dial that display a pressure of the nozzle supply lines 230 adjacent the second valve 228.

In some embodiments, a user manually controls the second valve 228 based on the pressure detected by the pressure gauge 234. Specifically, the second valve 228 is controlled such that a predetermined pressure is detected by the pressure gauge 234 in the nozzle supply lines 230. In some embodiments, the second valve 228 is configured to be controlled to have the inlet connected to the pump outlet line 226 remain open and partially opening the saddle tank return lines 232 such that the predetermined pressure is detected by the pressure gauge 234 in the nozzle supply lines 230, and the saddle tank return lines 232 be partially open to return a portion of the fluid flowing through the second valve 228 to the pair of saddle tanks 200. As such, when the pump 204 is activated by the timer ECU 300 to the on state, fluid from the pair of saddle tanks 200 is drawn through the pump supply lines 220, the first valve 222, the pump inlet line 224, the pump 204, the pump outlet line 226, the second valve 228, the nozzle supply lines 230, and discharged through the plurality of inner spray nozzles 202A and the plurality of outer spray nozzles 202B.

In some embodiments, a portion of the fluid flowing through the second valve 228 is directed into the saddle tank return lines 232 to be returned to the pair of saddle tanks 200 such that the fluid pressure in the nozzle supply lines 230, detected by the pressure gauge 234, is at a predetermined pressure. As such, the portion of the fluid flowing through the second valve 228 into the saddle tank return lines 232 is returned to the pair of saddle tanks 200.

Referring now to FIG. 3, the plurality of inner spray nozzles 202A and the plurality of outer spray nozzles 202B are mounted to the trailer 100. Particularly, the plurality of inner spray nozzles 202A are mounted to the pair of rear trailer frame members 106, and the plurality of outer spray nozzles 202B are mounted to the pair of fenders 120. In some embodiments, each of the wheel assemblies 110 is provided with at least one inner spray nozzle 202A directed at an inner side of each of the wheel assemblies 110 and at least one outer spray nozzle 202B directed at an outer side of each of the wheel assemblies 110. As described above, each of the plurality of inner spray nozzles 202A and each of the plurality of outer spray nozzles 202B are in fluid communication with the fluid lines 208 such that fluid output by the pump 204 flows to the plurality of inner spray nozzles 202A and the plurality of outer spray nozzles 202B through the nozzle supply lines 230.

Each of the plurality of inner spray nozzles 202A are attached to a mounting bracket 240A that is mounted to the pair of rear trailer frame members 106, and each of the plurality of outer spray nozzles 202B are attached to a mounting bracket 240B that is mounted to an underside of the fenders 120. In embodiments, each of the mounting brackets 240A and 240B include one or more slots 242A and 242B through which a fastener 244A and 244B extends such that the direction of spray from the inner spray nozzles 202A and outer spray nozzles 202B may be adjusted. In some embodiments, the fasteners 244A and 244B extends through the slots 242A and 242B to engage with the inner spray nozzle 202A and the outer spray nozzle 202B to secure an orientation of the inner spray nozzle 202A and the outer spray nozzle 202B with respect to the mounting brackets 240A and 240B. In some embodiments, the fasteners 244A and 244B may be loosened to as to adjust the orientation of the inner spray nozzle 202A and the outer spray nozzle 202B with respect to the mounting brackets 240A and 240B so as to adjust a spray direction of the inner spray nozzle 202A and the outer spray nozzle 202B.

In some other embodiments, a biasing member is provided between the mounting brackets 240A and 204B and the inner spray nozzle 202A and the outer spray nozzle 202B, respectively, to bias the inner spray nozzle 202A and the outer spray nozzle 202B with respect to the mounting brackets 240A and 240B towards a preset orientation.

The plurality of inner spray nozzles 202A are directed towards the inner side of the wheel assemblies 110 so as to spray a fluid onto the inner surface of the wheel rim 113, the brake 116, the spindle 117, the suspension component 118, and the axle 114. The plurality of outer spray nozzles 202B are directed towards the outer surface of the wheel assemblies 110 so as to spray a fluid onto an outer surface of the wheel rim 113 include spraying the fluid onto the lug nuts 113A of the wheel rim 113. The outer surface of the wheel rim 113 is opposite the inner surface of the wheel rim 113.

In some embodiments, the plurality of inner spray nozzles 202A are different than the plurality of outer spray nozzles 202B. Specifically, the plurality of inner spray nozzles 202A have a discharge characteristic that is different than a discharge characteristic of the plurality of outer spray nozzles 202B. In some embodiments, the discharge characteristic of the plurality of inner spray nozzles 202A and the plurality of outer spray nozzles 202B is a shape of spray such as without limitation a mist, full cone, hollow cone flat, and jet etc. In some embodiments, the discharge characteristic is an output pressure or a flow rate of fluid from the nozzle. In some embodiments, the plurality of inner spray nozzles 202A are a full jet spray or a full cone spray having a flow rate of 0.81 gallons per minute (GPM), and the plurality of outer spray nozzles 202B are a full jet spray or a full cone spray having a flow rate of 0.23 gallons per minute (GPM).

In some embodiments, the plurality of inner spray nozzles 202A and the plurality of outer spray nozzles 202B are formed of a two-piece construction that allow for the ability to clean debris from an output orifice of the spray nozzles. In some other embodiments, the plurality of inner spray nozzles 202A and the plurality of outer spray nozzles 202B are rotary nozzles that are configured to rotate about an axis to distribute a spray of fluid from the fluid lines 208.

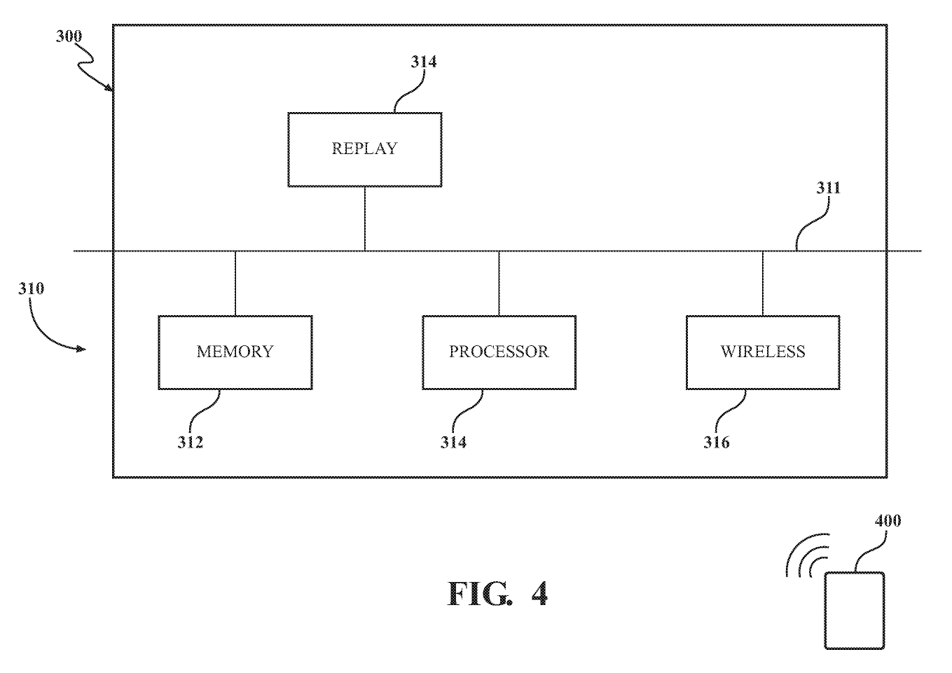

Referring now to FIGS. 4, embodiments of the timer ECU 300 are schematically depicted. Particularly, the timer ECU 300 may include a microprocessor 310 and a relay switch 320 (also referred to herein simply as a “relay”). The microprocessor 310 may include a memory module 312, a processor 314, and a wireless communication module 316. A communication path 311 interconnects the microprocessor 310 and the relay 320. The communication path 311 may be formed from any medium that is capable of transmitting a signal such as, for example, conductive wires, conductive traces, optical waveguides, or the like. Moreover, the communication path 311 may be formed from a combination of mediums capable of transmitting signals. In one embodiment, the communication path 311 comprises a combination of conductive traces, conductive wires, connectors, and buses that cooperate to permit the transmission of electrical data signals to components such as processors, memories, sensors, input devices, output devices, and communication devices. The term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 311 communicatively couples the various components of the timer ECU 300. As used herein, the term “communicatively coupled” means that coupled components are capable of exchanging data signals with one another such as, for example, electrical signals via conductive medium, electromagnetic signals via air, optical signals via optical waveguides, and the like.

Still referring to FIG. 4, the processor 314 may be any device capable of executing machine readable instructions. Accordingly, the processor 314 may be a controller, an integrated circuit, a microchip, a computer, or any other computing device. The processor 314 is communicatively coupled to the other components of the timer ECU 300 by the communication path 311. While the embodiment depicted in FIG. 4 includes only one processor 314, other embodiments may include multiple processors communicatively coupled with one another by the communication path 311.

The memory module 312 of the timer ECU 300 is coupled to the communication path 311 and communicatively coupled to the processor 314. The memory module 312 may comprise RAM, ROM, flash memories, hard drives, or any device capable of storing machine readable instructions such that the machine readable instructions can be accessed and executed by the processor 314. The machine readable instructions may comprise logic or algorithm(s) written in any programming language of any generation (e.g., 1GL, 2GL, 3GL, 4GL, or 5GL) such as, for example, machine language that may be directly executed by the processor 314, or assembly language, object-oriented programming (OOP), scripting languages, microcode, etc., that may be compiled or assembled into machine readable instructions and stored on the memory module 312. Alternatively, the machine readable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The wireless communication module 316 is coupled to the communication path 311 and communicatively coupled to the processor 314. The wireless communication module 316 may be any device capable of transmitting and/or receiving data via a network. Accordingly, the wireless communication module 316 may include a communication transceiver for sending and/or receiving any wired or wireless communication. For example, the wireless communication module 316 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the wireless communication module 316 includes hardware configured to operate in accordance with the Bluetooth® wireless communication protocol. In some embodiments, the wireless communication module 316 may be a wireless communication module 316 configured to transmit and/or receive wireless signals according to the Bluetooth® 4.0 communication protocol. In such embodiments, the wireless communication module 316 may transmit and receive signals using less energy than other less energy efficient wireless communication protocols. However, in some embodiments the wireless communication module 316 is configured to transmit and/or receive wireless signals in accordance with a wireless communication protocol other than the Bluetooth® 4.0 communication protocol. Some embodiments may not include the wireless communication module 316, such as embodiments that include a wired communication module for transmitting and/or receiving data via a wired network.

The wireless communication module 316 is configured to communicate with a user's electronic mobile computing device 4000. In some embodiments, the mobile computing device 400 includes a computer, a smartphone, a tablet, garage door opener, and/or a key fob. The mobile computing device 400 is configured to communicate with the timer ECU 300 through the wireless communication module 316 through Wi-Fi, Bluetooth®, and/or the like to the wireless communication module 316 for the purpose of actuating the pump 204, as described in greater detail herein. Furthermore, mobile computing device 400 is configured to remotely connect to the wireless communication module 316 to remotely start the activation of the pump 204 by the timer ECU 300 which activates the pump 204 from the off state to the on state, in which the timer ECU 300 controls the pump 204 to be supplied with electric power from the battery 206 so as to have the pump 204 operate to pump fluid from the at least one saddle tank 200 to the plurality of inner spray nozzles 202A and the plurality of outer spray nozzles 202B for the predetermined period of time.

Still referring to FIG. 4, the relay 320 is coupled to the communication path 311 and communicatively coupled to the processor 314. The relay 320 is switched between states, actuations, positions, and/or the like based on an output signal from the processor 314. As such, the switching between states, actuations, positions, and/or the like may cause the relay 320 to energize the pump 204 with electrical power from the battery 206 for the predetermined period of time and to de-energize the pump 204 from the electrical power from the battery 206 after elapse of the predetermined period of time.

In some embodiments, the timer ECU 300 is configured to send a notification to the mobile computing device 400 through the wireless communication module 316 upon start of the activation of the pump 204 from the off state to the on state and upon deactivation of the pump 204 from the on state to the off state after the elapse of the predetermined period of time. In some embodiments, the timer ECU 300 is configured to store, in the memory module 312 the number of times the pump 204 has been activated and the time and date in which the pump 204 has been switched from the off state to the on state and from the on state to the off state. In some embodiments, the timer ECU 300 is configured to send a notification to the mobile computing device 400, through the wireless communication module 316, the number of times the pump 204 has been activated and the time and date in which the pump 204 has been switched from the off state to the on state and from the on state to the off state. In some embodiments, the timer ECU 300 is configured to send a tamper alert to the mobile computing device 400, through the wireless communication module 316, upon disruption of the activation of the pump 204. For example, when the pump 204 is deactivated from the on state to the off state prior to the expiration of the predetermined period of time, the timer ECU 300 is configured to send the tamper alert to the mobile computing device 400, through the wireless communication module 316.

In some embodiments, the saddle tank return lines 232 may be disconnected from the pair of saddle tanks 200 and utilized to flush a motor of a boat received on the trailer 100 and/or rinse the boat received on the trailer 100. In such an embodiment, the second valve 228 is controlled to prohibit the flow of fluid to the nozzle supply lines 230 and permit the flow of fluid through the saddle tank return lines 232 to flush the motor of the boat or rinse the boat received on the trailer 100.

In one non-limiting embodiment of the portable trailer wheel rinsing system 10, the saddle tanks 200 are a pair of 15 gallon saddle tanks, the pump is a 7 gallon per minute (GPM) DELAVAN Model No. 7870-101Y-SM electric pump, the fluid lines 208 are a flexible 0.5 inch flexible fluid lines, the plurality of inner spray nozzles 202A are a 0.81 GPM full cone spray nozzles, and the plurality of outer spray nozzles 202B are a 0.23 GPM full cone spray nozzles. In some embodiments, the timer ECU 300 is a DC power switch timer or includes a DC power switch timer.

In operation, the two saddle tanks 200 are at least partially filled with fresh water as the fluid. In some embodiments, a salt dissolving solution may be added to the fresh water in the saddle tanks 200. In some embodiments, the predetermined period of time is set such that upon elapse of the predetermined period of time at least 50% of the fluid storage capacity of the pair of saddle tanks 200 has been used to rinse the trailer 100, specifically, the inner side and outer side of the wheel assemblies 110.

Typically, a boat is transported to boat dock (e.g., a truck may be used to pull the trailer 100 and the boat from an individual's home to a desired boat dock). The boat is unloaded into a body of salt water by backing the trailer 100 down a boat ramp into the salt water. During unloading of the boat from the trailer 100, at least one of the axles 114 with attached wheel assemblies 110 may be submersed in the salt water. The boat is removed from the trailer 100 and the trailer 100 and is pulled out of the salt water and parked in a parking lot, on the side of a road, etc., while the individual uses the boat to go fishing, sightseeing, skiing, etc. After the trailer 100 is parked, the individual activates the timer ECU 300, which in turn activates the pump 204. The pump 204 is controlled to pump and deliver fresh water from the saddle tanks 200 to the plurality of inner spray nozzles 202A and the plurality of outer spray nozzles 202B for the predetermined period of time by the timer ECU 300, after which the pump 204 stops pumping fresh water from the saddle tanks 200. In some embodiments, the timer ECU 300 is set and/or activated manually by the individual. In other embodiments, the timer ECU 300 is set and/or activated wirelessly, e.g., transmitting a wireless signal to the timer ECU 300 from the mobile computing device 400 such as a smartphone, key fob, garage door opener, or the like. During activation of the pump 204 in the on state, the plurality of inner spray nozzles 202A and the plurality of outer spray nozzles 202B direct and spray fresh water onto the wheel assemblies 110 such that the wheel assemblies 110 are rinsed with the fresh water and salt water and/or salt deposit on the wheel components is removed therefrom. As the wheel assemblies 110 are rinsed soon after submersion in salt water, salt deposits are prevented from forming on the wheel assemblies 110.

Upon returning to the boat to the boat dock, the individual backs the trailer 100 down the boat ramp into the salt water such that at least one of the axles 114 with attached wheel assemblies 110 is submersed in the salt water. The boat is loaded onto the trailer 100 and the trailer 100 with the boat is pulled out of the salt water and parked while the individual ensures the boat is properly secured to the trailer 100, removes equipment, trash, etc. from the boat, and the like. Then, the individual pulls the trailer 100 and the boat to a desired location (e.g., home). After the trailer 100 with the boat is removed from the salt water, e.g., while the trailer 100 is parked or when the individual starts pulling the trailer 100 with the boat to the desired location, the individual activates the timer ECU 300, which in turn activates the pump 204. The pump 204 pumps fresh water from the saddle tanks 200 to the plurality of inner spray nozzles 202A and the plurality of outer spray nozzles 202B for the same or a second predetermined amount of time different from the predetermined amount of time and fresh water is sprayed onto the wheel assemblies 110 by the plurality of inner spray nozzles 202A and the plurality of outer spray nozzles 202B. That is, the wheel assemblies 110 are rinsed and salt water and/or salt deposit on the wheel components is removed.

It should be understood that embodiments of the portable trailer wheel rinsing systems disclosed herein may reduce corrosion of wheel assembly components caused by salt water, salt deposits, etc. Particularly, the embodiments of the portable trailer wheel rinsing systems disclosed herein provide for rinsing of trailer wheel assembly components after the trailer has unloaded a boat into a body of salt water and after a boat has been loaded onto the trailer out of the body salt water. The timer, saddle tanks, pump and spray nozzles provide for convenient and timely spraying of the wheel assembly components with fresh water before salt water on the wheel assembly components can dry, and without the need to travel to a car wash and/or wait until arriving a location such as home before spraying of the wheel assemblies with fresh water.

Directional terms as used herein—for example top, upper, bottom, and lower—are made only with reference to the figures as drawn and are not intended to imply absolute orientation unless otherwise expressly stated.

While particular embodiments have been illustrated and described herein, it should be understood that various other changes and modifications may be made without departing from the spirit and scope of the claimed subject matter. For example, the portable trailer wheel rinsing system 10 disclosed herein may be utilized to rinse or flush a motor of a boat with fresh water and/or to rinse a portion of the boat itself with fresh water. In some embodiments the portable trailer wheel rinsing system 10 disclosed herein may include a dedicated boat motor flushing/rinsing hose (not shown) through which the pump 204 delivers fresh water from the saddle tanks 200 and flushes the motor of the boat. Also, the portable trailer wheel rinsing system 10 disclosed herein may include: a remote start as discussed above; a reminder alert to activate the timer ECU 300 (e.g., a software application on a smartphone); a tracking system that records the number of times the portable trailer wheel rinsing system 10 has been used; a tamper alert that notifies the user when the electric circuit of the portable trailer wheel rinsing system 10 has been disrupted; and/or two piece spray nozzles that allow for cleaning of debris from orifices thereof.

While various aspects of the claimed subject matter have been described herein, such aspects need not be utilized in combination and the specification and the appended claims should be interpreted broadly.

What is claimed is:

1. A portable trailer wheel rinsing system comprising:
at least one liquid storage tank configured to be attached to a trailer;
a plurality of spray nozzles configured to be attached to the trailer and direct a liquid spray onto at least one wheel assembly of the trailer, the plurality of spray nozzles in fluid communication with the at least one liquid storage tank;
a pump in fluid communication with the at least one liquid storage tank and the plurality of spray nozzles; and
a timer in electrical communication with the pump;
wherein the timer is configured to activate the pump for a predetermined amount of time and the pump is configured to pump a liquid from the at least one liquid storage tank through the plurality of spray nozzles such that the liquid spray is applied to the at least one wheel assembly for the predetermined amount of time.

2. The portable trailer wheel rinsing system of claim 1, further comprising a battery in electrical communication with the pump, wherein the pump is an electrical pump and the battery provides electrical energy to the pump for the predetermined amount of time.

3. The portable trailer wheel rinsing system of claim 2, wherein the battery is a rechargeable battery.

4. The portable trailer wheel rinsing system of claim 1, wherein each of the plurality of spray nozzles are attached proximal to each of the at least one wheel assembly of the trailer such that a rinse liquid from the at least one liquid storage tank is sprayed onto each of the at least one wheel assembly by the plurality of spray nozzles for the predetermined amount of time.

5. The portable trailer wheel rinsing system of claim 1, wherein the at least one liquid storage tank is a pair of saddle tanks and the plurality of spray nozzles is two sets of spray nozzles with a first set of spray nozzles configured to direct the liquid spray to an inner side of the at least one wheel assembly, and a second set of spray nozzles configured to direct the liquid spray to an outer side of the at least one wheel assembly.

6. A trailer with a trailer wheel rinsing system comprising:
a trailer with at least two wheel assemblies comprising a brake and a suspension component;
at least one liquid storage tank containing a rinse liquid attached to the trailer;
at least two spray nozzles attached to the trailer and positioned to spray the rinse liquid onto the brake and the suspension component;
a pump in fluid communication with the at least one liquid storage tank and the at least two spray nozzles; and
a timer in electrical communication with the pump;
wherein the timer activates the pump for a predetermined amount of time, the pump delivers pressurized rinse liquid from the at least one liquid storage tank to the at least two spray nozzles such that the rinse liquid is sprayed onto and rinses the brake and the suspension component of each wheel assembly for the predetermined amount of time.

7. The trailer with the trailer wheel rinsing system of claim 6, further comprising a battery in electrical communication with the pump, wherein the pump is an electrical pump and the battery provides electrical energy to the pump for the predetermined amount of time.

8. The trailer with the trailer wheel rinsing system of claim 7, wherein the battery is a rechargeable battery.

9. The trailer with the trailer wheel rinsing system of claim 6, wherein the rinse liquid is fresh water and the fresh water rinses salt water off of the brake and the suspension component of each of the at least two wheel assemblies for the predetermined amount of time.

10. A method for rinsing salt water off of a wheel assembly of a boat trailer, the method comprising:
activating a timer electrically connected to an electric pump attached to the boat trailer, wherein the timer activates the electric pump for a predetermined amount of time;
pumping fresh water contained in at least one liquid storage tank attached to the boat trailer to a plurality of spray nozzles attached to the boat trailer using the electric pump, wherein the plurality of spray nozzles are positioned proximal to and facing a plurality of wheel assemblies of the boat trailer;
spraying the plurality of wheel assemblies with the fresh water for the predetermined amount of time using the plurality of spray nozzles.

11. The method of claim 10, wherein the plurality of wheel assemblies are sprayed with the fresh water for the predetermined amount of time after a boat has been unloaded into a salt water body from the boat trailer and the boat trailer has been parked in a parking lot.

12. The method of claim 10, wherein the plurality of wheel assemblies are sprayed with the fresh water for the predetermined amount of time after a boat has loaded on the boat trailer from a salt water body.

13. The method of claim 10, wherein:
the plurality of wheel assemblies are sprayed with the fresh water for a first predetermined amount of time after a boat has been in a salt water body from the boat trailer and the boat trailer has been parked in a parking lot; and
the plurality of wheel assemblies are sprayed with the fresh water for a second predetermined amount of time after the boat has been loaded on the boat trailer from the salt water body.

14. The method of claim 10, wherein the plurality of spray nozzles includes a first set of spray nozzles and a second set of spray nozzles, the first set of spray nozzles are configured to spray the fresh water to an inner side of the plurality of wheel assemblies, and the second set of spray nozzles are configured to spray the fresh water to an outer side of the plurality of wheel assemblies.
